(19) United States
(12) Patent Application Publication
(10) Pub. No.: US 2023/0027407 A1
(43) Pub. Date: Jan. 26, 2023

(54) COOLING CIRCUIT WITH SEVERAL COOLING TEMPERATURES FOR MOTOR VEHICLE AND METHOD FOR OPERATING SUCH COOLING CIRCUIT

(71) Applicant: DENSO AUTOMOTIVE Deutschland GmbH, Eching (DE)

(72) Inventors: Ariel MARASIGAN, Eching (DE); Dennis WLEKLIK, Eching (DE); Hiroyuki KOBAYASHI, Eching (DE); Shivakumar BANAKAR, Eching (DE)

(21) Appl. No.: 17/960,399

(22) Filed: Oct. 5, 2022

Related U.S. Application Data
(63) Continuation of application No. PCT/JP2021/014107, filed on Apr. 1, 2021.

(30) Foreign Application Priority Data
Apr. 8, 2020 (DE) 102020204555.0

(51) Int. Cl. B60H 1/00; B60L 58/26; B60L 58/27; B60H 1/03; H01M 10/625

(52) U.S. Cl. CPC B60H 1/00007; B60L 58/26; B60L 58/27; B60H 1/03; B60H 1/00485; B60H 1/00571; H01M 10/625; B60L 2240/425

(57) ABSTRACT

A cooling circuit for a vehicle includes a single cooler, a refrigeration machine, a first heat-generating device, a second heat-generating device, a coolant pump arrangement configured to pump a coolant, a valve arrangement, and an electronic control module. The first heat-generating device requires the coolant at a first coolant temperature level. The second het-generating device requires the coolant at a second coolant temperature level. The valve arrangement is configured to supply the coolant from the first and second heat-generating devices to the refrigeration machine and/or to the single cooler. The electronic control module is designed to control a temperature of the coolant at coolant inlets of the first and second heat-generating devices by varying flow rates of the coolant through the refrigeration machine and/or the single cooler.

### CROSS REFERENCE TO RELATED APPLICATION

The present application is a continuation application of International Patent Application No. PCT/JP2021/014107 filed on Apr. 1, 2021, which designated the U.S. and claims the benefit of priority from German Patent Application No. DE 102020204555.0, filed on Apr. 8, 2020. The entire disclosures of all of the above applications are incorporated herein by reference.

### TECHNICAL FIELD

The present disclosure relates to a cooling circuit with several cooling temperatures for motor vehicles and a method for operating such a cooling circuit.

### BACKGROUND ART

For the thermal management—heating and cooling—of electric and hybrid vehicles, coolant temperatures at different temperature levels are required. Two separate coolant circuits having two coolers are used for this purpose.

### SUMMARY

According to an aspect of the present disclosure, a cooling circuit includes a single cooler and different coolant temperatures are generated in that the hot coolant flows from the two heat generators are fed by the valve arrangement to the refrigerating machine and the cooler in certain ratios. An electronic control module is used to control and regulate the required coolant temperatures and to activate the valve arrangement.

### BRIEF DESCRIPTION OF DRAWINGS

FIG. 1 shows a first embodiment of the present disclosure with battery and motor as heat-generating devices and two 3-way valves and a bypass.

FIG. 2 shows a second embodiment of the present disclosure with battery and motor as heat-generating devices, a 3-way valve, a 4-way valve, and a bypass.

FIG. 3 shows a third embodiment of the present disclosure with two bypasses.

FIG. 4 shows a fourth embodiment of the present disclosure with three heat-generating devices.

FIG. 5 shows a first operating mode of the third embodiment according to FIG. 3 at low ambient temperatures, for example in winter.

FIG. 6 shows a second operating mode of the third embodiment according to FIG. 3 also at low ambient temperatures, for example in winter.

FIG. 7 shows a third operating method of the third embodiment at moderate ambient temperatures, for example at temperatures on the morning of a summer day.

FIG. 8 shows a fourth operating method of the third embodiment at higher ambient temperatures, for example in summer.

FIG. 9 shows a fifth operating method of the third embodiment at even higher ambient temperatures, for example on a very hot summer day.

FIG. 10 shows a sixth operating method of the third embodiment at ambient temperatures on a very hot summer day and in which the battery is additionally charged quickly.

### DESCRIPTION OF EMBODIMENTS

To begin with, examples of relevant techniques will be described. For the thermal management—heating and cooling—of electric and hybrid vehicles, coolant temperatures at different temperature levels are required. For the battery, the coolant has to have a temperature of approximately 25° C. at the inlet, wherein the motor/drivetrain require a higher temperature level of approximately 50° C. Two separate coolant circuits having two coolers are used for this purpose. This means increased material and installation expenditure—two coolers—and under certain conditions only one of the two cooling circuits is required, which is equivalent to a waste of resources.

The present disclosure provides a more effective cooling circuit with several coolant temperatures for motor vehicles and a method for the effective operation of such a cooling circuit. A cooling circuit includes a single cooler and different coolant temperatures are generated in that the hot coolant flows from the two heat generators are fed by the valve arrangement to the refrigerating machine and the cooler in certain ratios. An electronic control module is used to control and regulate the required coolant temperatures and to activate the valve arrangement.

It is advantageous here if the heat-generating devices are provided with bypasses. The bypasses simplify the control and regulation of the cooling circuit. The bypasses can be implemented as explicit bypass lines or alternatively by an air flow blocking device in the single cooler or by a refrigerant blocking device in the refrigeration machine. When the air flow through the cooler is blocked, the coolant line to and from the cooler acts as a bypass to the second heat-generating device. If the flow of refrigerant to the refrigeration machine is blocked, the coolant line to and from the refrigeration machine acts as a bypass to the first heat-generating device.

The cooling circuit advantageously comprises a valve arrangement with a plurality of multi-way valves and in particular of proportional multi-way valves, which is also determined by the number of heat-generating devices. The use of proportional multi-way valves reduces the number of valves required in the valve arrangement.

According to another aspect, two proportional 3-way valves and a first and a second heat-generating device and a bypass for the first heat-generating device are provided.

According to another aspect, two proportional 4-way valves and a first and a second heat-generating device are provided with and without bypass for the first heat-generating device.

According to another aspect, two proportional 4-way valves and a first and a second heat-generating device and bypasses for the first and second heat-generating devices are provided.

According to another aspect, three proportional 4-way valves, three heat-generating devices, and several bypasses are provided.

According to another aspect, a method for operating a cooling circuit with two heat-generating devices, each with a bypass and two multi-way valves are provided.

According to another aspect, different operating modes for different vehicle and environmental conditions are provided.

Further details, features, and advantages of the disclosure result from the following description of preferred embodiments.

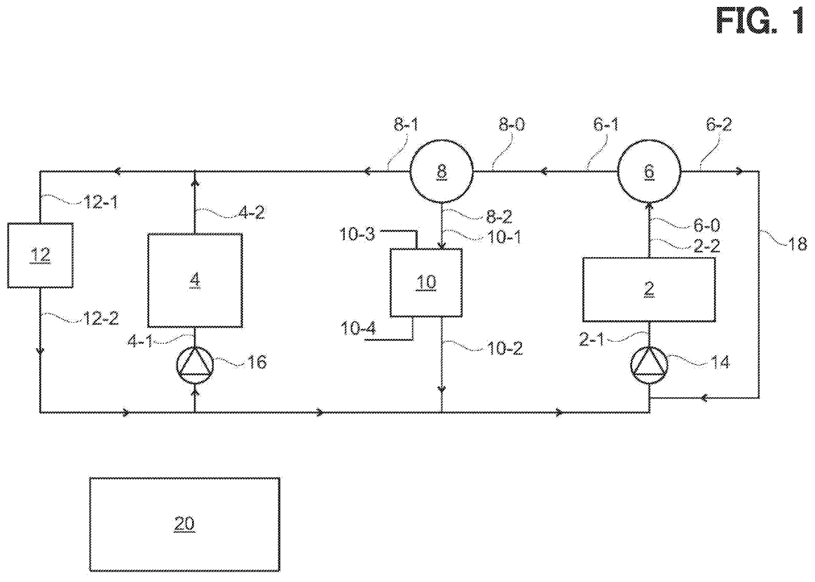

FIG. 1 shows a first embodiment of the present disclosure in the form of a cooling circuit for an electric vehicle. The cooling circuit according to FIG. 1 includes a battery 2 as the first heat-generating device, a motor with drive train 4 as the second heat-generating device, a first and a second multi-way valve 6 and 8 in the form of 3-way valves, a refrigeration machine 10, a single cooler—air/liquid heat exchanger 12, a first circulation pump 14, and a second circulation pump 16. The battery 2 and the motor with drive train 4 each includes a coolant inlet 2-1, 4-1 and a coolant outlet 2-2, 4-2. The first and second 3-way valve 6 and 8 each includes an inlet 6-0, 8-0, a first outlet 6-1, 8-1, and a second outlet 6-2, 8-2. The refrigeration machine 10 includes a coolant inlet 10-1, a coolant outlet 10-2, a coolant inlet 10-3, and a coolant outlet 10-4. The first circulation pump 14 is connected on the output side to the coolant inlet 2-1 of the battery 2 and the second circulation pump 16 is connected on the output side to the coolant inlet 4-1 of the motor with drive train 4. That is, the first circulation pump 14 has an output end connected to the coolant inlet 2-1 of the battery 2. The second circulation pump 16 has an output end connected to the coolant inlet 4-1 of the motor with drive train 4. The battery 2 is provided with a first bypass in the form of a first bypass line 18.

The coolant outlet 2-2 of the battery 2 is connected to the inlet 6-0 of the first 3-way valve 6. The first outlet 6-1 of the first 3-way valve 6 is connected to the inlet 8-0 of the second 3-way valve 8. The second outlet 6-2 of the first 3-way valve 6 is connected to the first bypass line 18, which opens into the inlet of the first circulation pump 14. The first outlet 8-1 of the second 3-way valve 8 is connected to the coolant inlet 12-1 of the single cooler 12. The second outlet 8-2 of the second 3-way valve 8 is connected to the coolant inlet 10-1 of the refrigeration machine 10. The coolant outlet 12-2 of the single cooler 12 is connected to the inlet of the second circulation pump 16, the coolant outlet 10-2 of the refrigeration machine, the inlet of the first circulation pump 14, and the first bypass 18.

The control and regulation of the cooling circuit is carried out by an electronic control module which is connected to the individual components and to temperature and flow sensors (not shown). By varying the flow rates to the cooler 12 and/or the refrigeration machine, different cooling temperature levels may be effectively implemented for the battery 2 and for the motor with drive train 4.

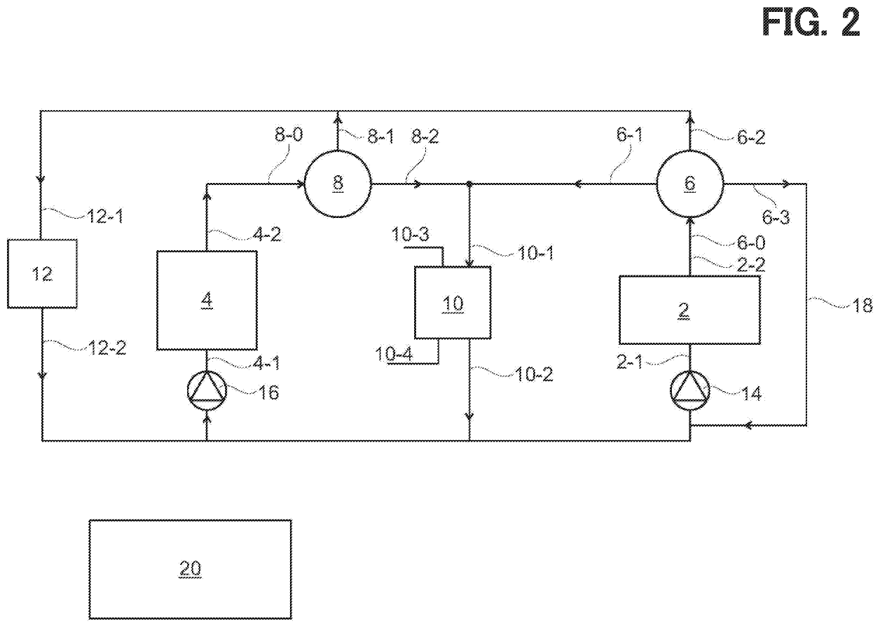

FIG. 2 shows a second embodiment of the present disclosure in the form of a cooling circuit for an electric vehicle. The cooling circuit according to FIG. 2 differs from the first embodiment according to FIG. 1 in that the first multi-way valve 6 is a 4-way valve and the second multi-way valve 8 is a 3-way valve. The first multi-way valve 6 therefore defines a third outlet 6-3.

As in the first embodiment, the coolant outlet 2-2 of the battery 2 is connected to the inlet 6-0 of the first multi-way valve 6—4-way valve. The first outlet 6-1 of the first multi-way valve 6 is connected to the coolant inlet 10-1 of the refrigeration machine 10. The second outlet 6-2 of the first multi-way valve 6 is connected to the coolant inlet 12-1 of the single cooler 12. The third outlet 6-3 of the first multi-way valve 6 is connected to the first bypass line 18, which opens into the inlet of the first circulation pump 14. The coolant outlet 4-2 of the motor with drive train 4 is connected to the inlet 8-0 of the second multi-way valve 8—3-way valve. The first outlet 8-1 of the second multi-way valve 8 is connected to the coolant inlet 12-1 of the single cooler 12. The second outlet 8-2 of the second multi-way valve 8 is connected to the coolant inlet 10-1 of the refrigeration machine 10.

The remaining structure of the second embodiment is the same as the structure of the first embodiment.

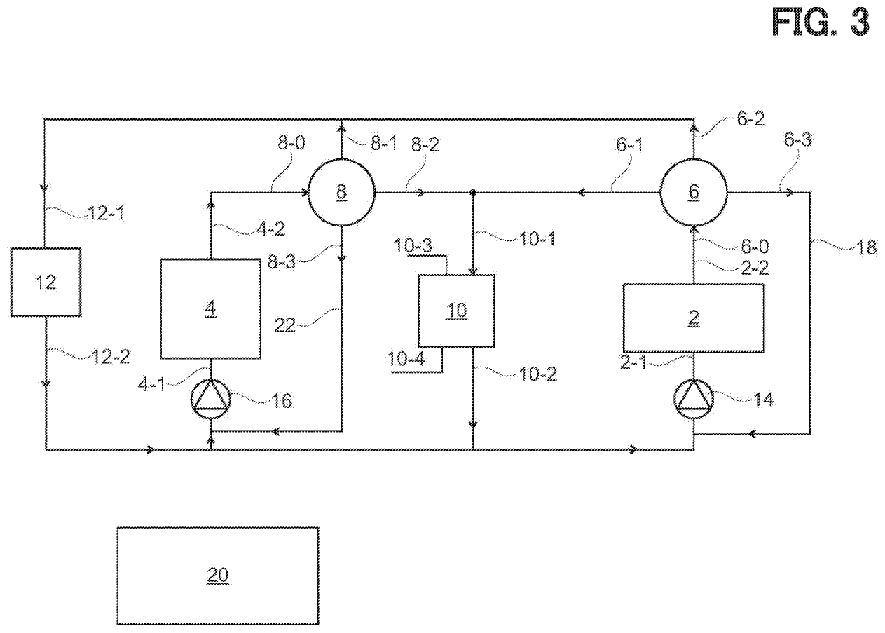

FIG. 3 shows a third embodiment of the present disclosure, which differs from the second embodiment according to FIG. 2 only in that the motor with drive train 4 is provided with a second bypass in the form of a second bypass line 22 and that the second multi-way valve 8 is also a 4-way valve, which additionally has a third outlet 8-3. The third outlet 8-3 of the second multi-way valve 8 is connected to the bypass line 22, which opens into the inlet of the second circulation pump.

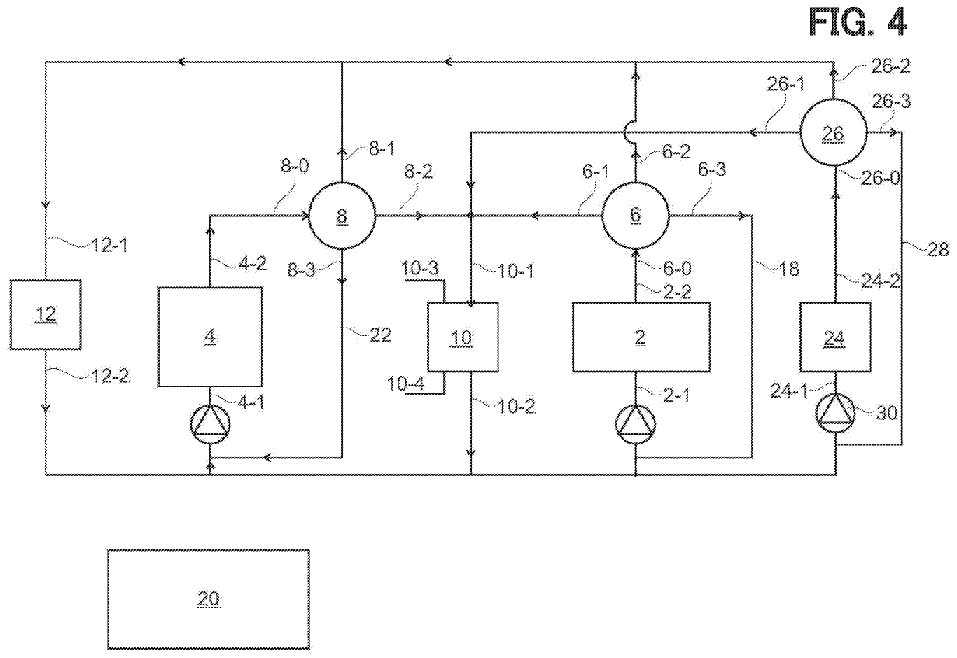

FIG. 4 shows a fourth embodiment of the present disclosure, which differs from the third embodiment in that, in addition to the first and second heat-generating devices 2, 4, a third heat-generating device 24 with a third multi-way valve 26, a third bypass in the form of a third bypass line 28, and a third circulation pump 30 are integrated into the cooling circuit. The third heat-generating device 24 comprises a coolant inlet 24-1 and a coolant outlet 24-2. The third multi-way valve 26 comprises an inlet 26-0, a first outlet 26-1, a second outlet 26-2 and a third outlet 26-3. The coolant outlet 24-2 of the third heat-generating device 24 is connected to the inlet 26-0 of the third multi-way valve 26. The first outlet 26-1 of the third multi-way valve 26 is connected to the coolant inlet 10-1 of the refrigeration machine 10. The second outlet 26-2 of the third multi-way valve 26 is connected to the coolant inlet 12-1 of the single cooler 12. The third outlet 26-3 of the third multi-way valve 26 is connected to the third bypass line 28, which opens into the inlet of the third circulation pump 30. The inlet of the third circulation pump 30 is also connected to the coolant outlet 12-2 of the single cooler and to the coolant outlet 10-2 of the refrigeration machine 10. The first, second, and third heat-generating devices 2, 4, and 24 are thus integrated into the cooling circuit in parallel to one another.

The third heat-generating device 24 is, for example, a control computer of an electric vehicle.

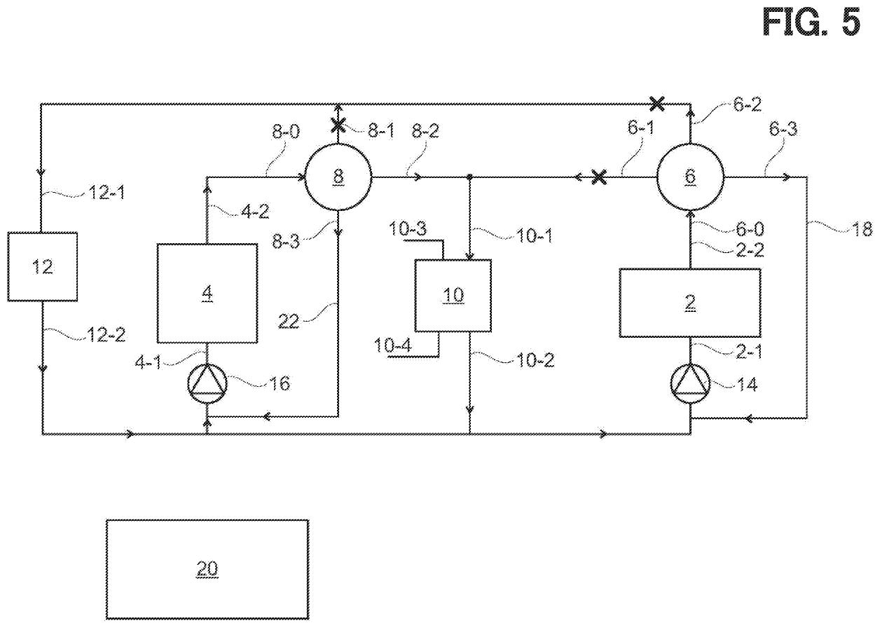

FIGS. 5 to 10 show operating modes of the third embodiment according to FIG. 3 for different operating states of an electric vehicle and at different ambient temperatures T_{amb}.

FIG. 5 illustrates an operating method of the third embodiment at low ambient temperatures, for example in winter, i.e., the ambient temperature T_{amb} is below a first temperature level T₁. The first and second outlet 6-1, 6-2 of the first multi-way valve 6 and the first outlet 8-1 of the second multi-way valve 8 are closed. The coolant flow from the battery 2 is recirculated by means of the first bypass 18 and the coolant flow from the motor with drive train 4 is partly fed to the refrigeration machine 10 and it is partly recirculated by means of the second bypass 22, i.e., part of the coolant flow from the motor with drive train 4 circulates in the partial circuit comprising the second circulation pump 16, the second multi-way valve 8, and again the second circulation pump 16. The coolant temperature at the coolant outlet 4-2 of the engine 4 is approximately 25° C. and at the coolant outlet 2-2 of the battery 2 is approximately 10° C.

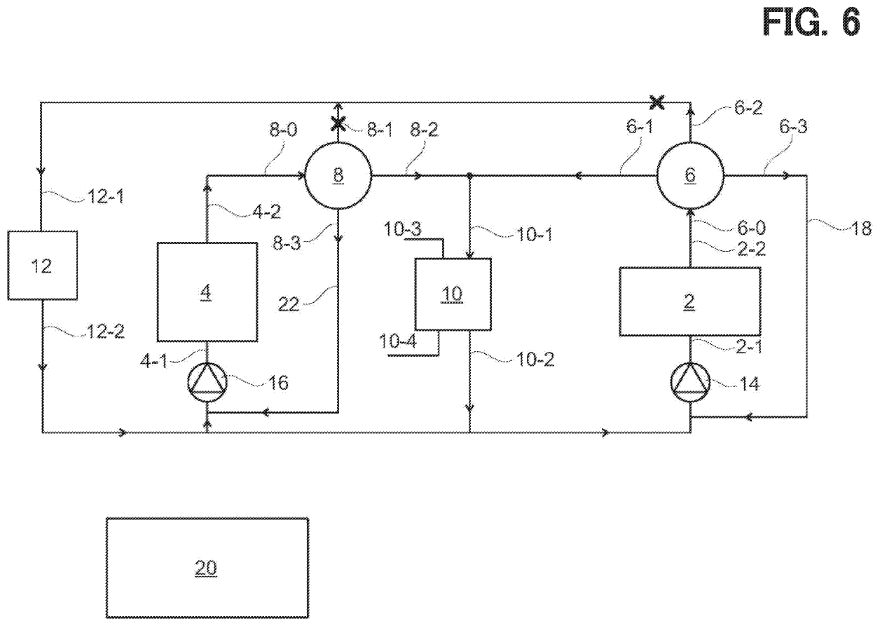

FIG. 6 illustrates an operating method of the third embodiment also at low ambient temperatures, for example in winter, i.e., the ambient temperature T_{amb} is below the first temperature level T₁. The coolant temperature at the coolant outlet 4-2 of the motor 4 is approximately 25° C. and at the coolant outlet 2-2 of the battery 2 is approximately 10° C. The second outlet 6-2 of the first multi-way valve 6 and the first outlet 8-1 of the second multi-way valve 8 are closed. Part of the coolant flow from the battery 2 and the motor with drive train 4 is cooled in the refrigeration machine.

At low ambient temperatures, for example in winter, in the operating method according to FIGS. 5 and 6, the refrigeration machine 10 is used as a heat pump. In addition to using the thermal energy from the ambient air, the waste heat from the motor/drive train 4 can also be used very efficiently. I.e., the waste heat from the motor/drive train 4 is not given off to the environment, but rather fed to the refrigeration machine 10 used as a heat pump and made usable at a higher temperature level for heating the vehicle cabin.

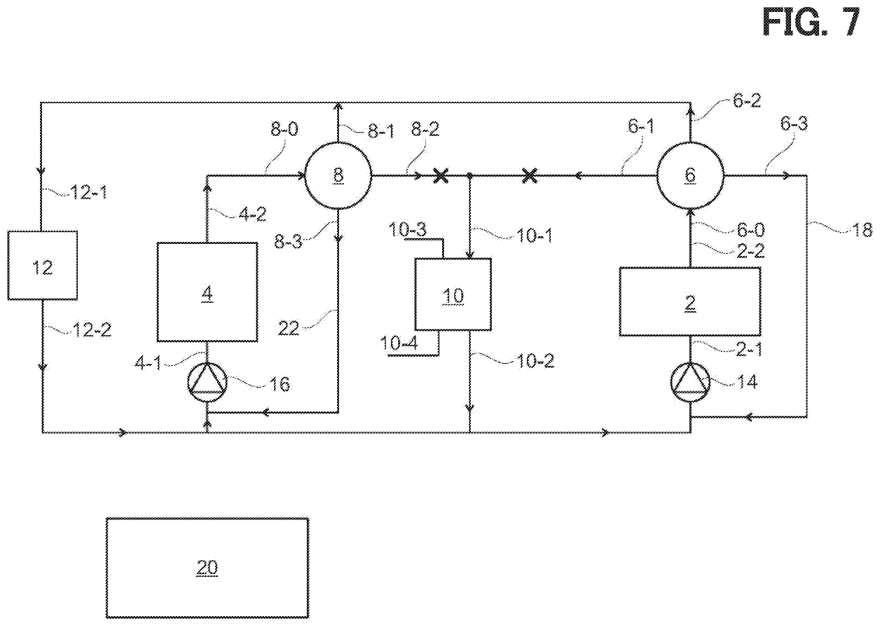

FIG. 7 illustrates an operating method of the third embodiment at ambient temperatures T_{amb} between the first temperature level T₁ and a second temperature level T₂, e.g., temperatures on the morning of a summer day. The coolant temperature at the coolant outlet 4-2 of the motor 4 is approximately 25° C. and at the coolant outlet 2-2 of the battery 2 is approximately 10° C. The first outlet 6-1 of the first multi-way valve 6 and the second outlet 8-2 of the second multi-way valve 8 are closed. The cooling of battery 2 and motor with drive train 4 takes place exclusively via the single cooler 12.

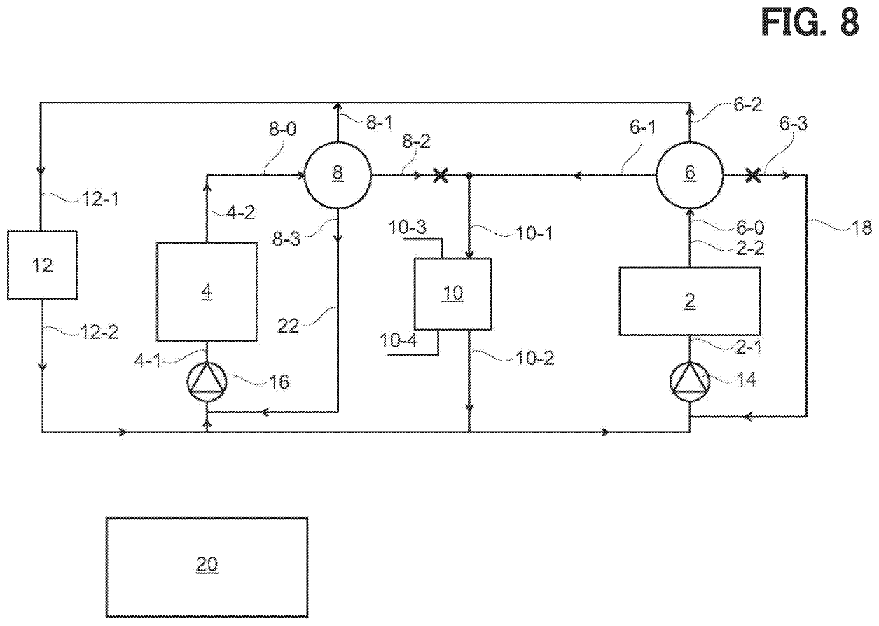

FIG. 8 illustrates an operating method of the third embodiment at ambient temperatures T_{amb} above the second temperature level T₂ and below a third temperature level T₃. The coolant temperature at the coolant outlet 4-2 of the motor 4 is approximately 50° C. and at the coolant outlet 2-2 of the battery 2 is approximately 25° C. The third outlet 6-3 of the first multi-way valve 6 and the second outlet 8-2 of the second multi-way valve 8 are closed. The battery 2 and motor with drive train 4 are cooled partially via the single cooler 12 and partially via the refrigeration machine 10.

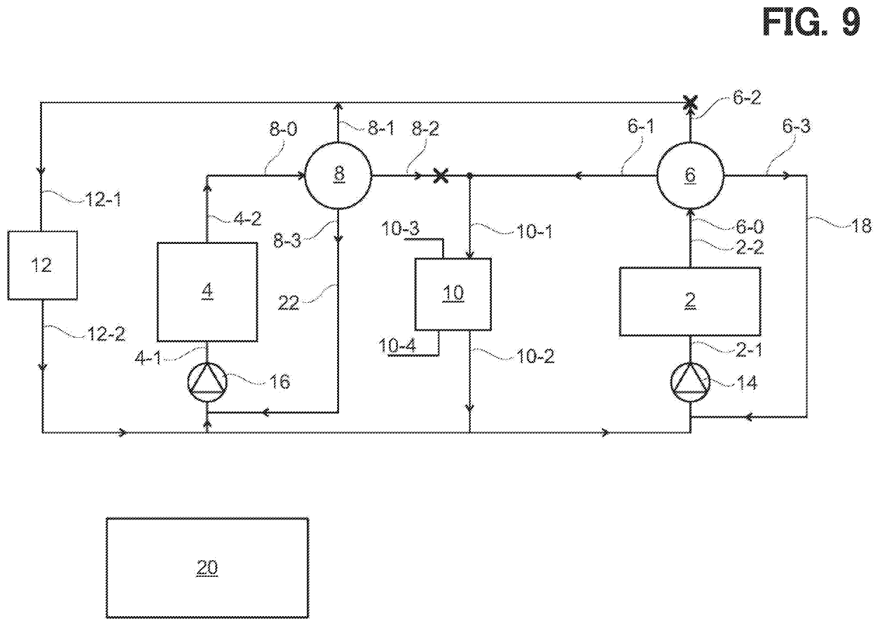

FIG. 9 illustrates an operating method of the third embodiment at ambient temperatures T_{amb} which are above the third temperature level T₃, for example, a very hot summer day. The coolant temperature at the coolant outlet 4-2 of the motor 4 is approximately 50° C. and at the coolant outlet 2-2 of the battery 2 is approximately 25° C. The second outlets 6-2, 8-2 of the first and second multi-way valve 6, 8 are closed. The battery 2 is cooled by the refrigeration machine and the motor with drive train 4 is cooled by the cooler 12.

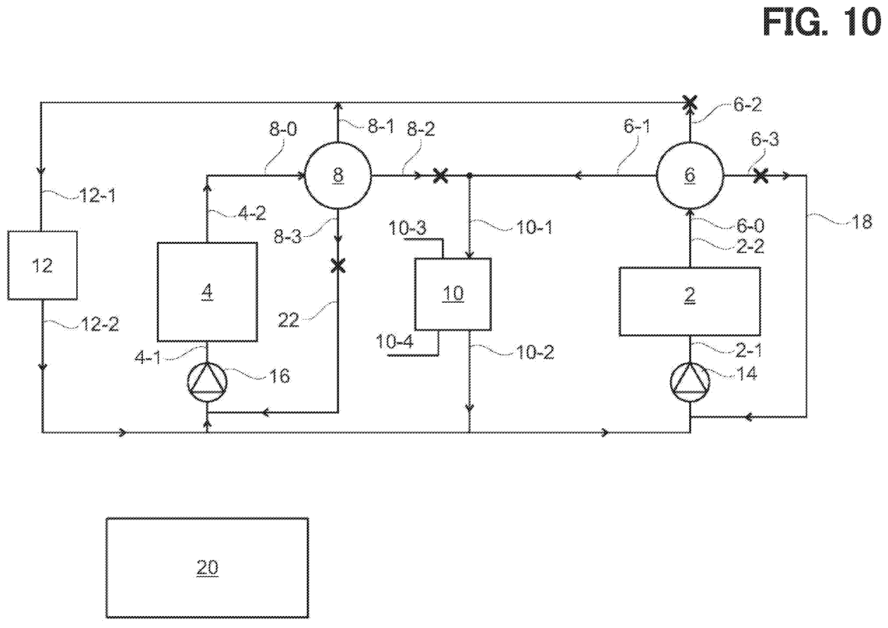

FIG. 10 illustrates an operating method of the third embodiment at ambient temperatures T_{amb}, which are above the third temperature level T₃, e.g., a very hot summer day and the battery 2 is charged quickly. The coolant temperature at the coolant outlet 4-2 of the engine is above the ambient temperature T_{amb} and the coolant temperature at the coolant outlet 2-2 of the battery 2 is between 30° C. and 40° C. The second and third outlets 6-2, 6-3, 8-2, 8-3 of the first and second multi-way valve 6, 8 are closed. The motor with drive train 4 is cooled via the cooler 12 and the battery 2 is cooled via the refrigeration machine 10.

The following are exemplary values for the three temperature levels T₁ to T₃:

T₁ 0° C. to 5° C.;

T₂ 20° C.;

T₃ 30° C.

What is claimed is:

1. A cooling circuit with several cooling temperatures for a vehicle, comprising:
a single cooler which has a coolant inlet and a coolant outlet;
a refrigeration machine which has a coolant inlet and a coolant outlet;
a first heat-generating device with a coolant inlet and a coolant outlet, which requires a coolant at a first coolant temperature level;
a second heat-generating device with a coolant inlet and a coolant outlet, which requires the coolant at a second coolant temperature level;
a coolant pump arrangement for pumping the coolant in the cooling circuit;
a valve arrangement for supplying the coolant from the first and second heat-generating devices to the refrigeration machine and/or to the single cooler; and
an electronic control module which is connected to the components of the cooling circuit and designed to control a temperature of the coolant at the coolant inlets of the first and second heat-generating devices by varying a flow rate of the coolant through the refrigeration machine and/or the single cooler, wherein
at least one of the first heat-generating device or the second heat-generating device is provided with a bypass.

2. The cooling circuit according to claim 1, wherein
the first heat-generating device is provided with a first bypass.

3. The cooling circuit according to claim 2, wherein
the first bypass is implemented by a refrigerant blocking device in the refrigeration machine.

4. The cooling circuit according to claim 1, wherein
the second heat-generating device is provided with a second bypass.

5. The cooling circuit according to claim 4, wherein
the second bypass is realized by an air flow blocking device in the cooler.

6. The cooling circuit according to claim 1, wherein
the coolant pump arrangement includes a first and a second circulation pumps,
the first circulation pump includes an output end connected to the coolant inlet of the first heat-generating device, and
the second circulation pump includes an output end connected to the coolant inlet of the second heat-generating device.

7. The cooling circuit according to claim 1, wherein
the valve arrangement includes a plurality of multi-way valves and in particular of proportional multi-way valves.

8. The cooling circuit according to claim 7, wherein
the plurality of multi-way valves includes a first multi-way valve and a second multi-way valve each having an inlet, a first outlet, and a second outlet,
the coolant pump arrangement includes a first circulation pump and a second circulation pump,
the first heat-generating device includes a first bypass in the form of a first bypass line,
the coolant outlet of the first heat-generating device is connected to the inlet of the first multi-way valve,
the first outlet of the first multi-way valve is connected to the inlet of the second multi-way valve,
the second outlet of the first multi-way valve is connected to the first bypass line which opens into an inlet of the first circulation pump,
the first outlet of the second multi-way valve is connected to the coolant inlet of the single cooler,
the second outlet of the second multi-way valve is connected to the coolant inlet of the refrigeration machine,
the coolant outlet of the single cooler is connected to the inlet of the first circulation pump and an inlet of the second circulation pump, and
the coolant outlet of the refrigeration machine is connected to the inlet of the first circulation pump and the inlet of the second circulation pump.

9. The cooling circuit according to claim 7, wherein
the plurality of multi-way valves includes a first proportional multi-way valve and a second proportional multi-way valve each having an inlet, a first outlet, and a second outlet,
the coolant pump arrangement includes a first circulation pump and a second circulation pump,
the inlet of the first proportional multi-way valve is connected to the coolant outlet of the first heat-generating device,
the first outlet of the first proportional multi-way valve is connected to the coolant inlet of the refrigeration machine,
the second outlet of the first proportional multi-way valve is connected to the coolant inlet of the single cooler,
the inlet of the second proportional multi-way valve is connected to the coolant outlet of the second heat-generating device,
the first outlet of the second proportional multi-way valve is connected to the coolant inlet of the single cooler,
the second outlet of the second proportional multi-way valve is connected to the coolant inlet of the refrigeration machine,
the coolant outlet of the single cooler is connected to an inlet of the second circulation pump and an inlet of the first circulation pump, and
the coolant outlet of the refrigeration machine is connected to the inlet of the first circulation pump and the inlet of the second circulation pump.

10. The cooling circuit according to claim 9, wherein
the first proportional multi-way valve further includes a third outlet which is connected to a first bypass in the form of a first bypass line which opens into the inlet of first circulation pump.

11. The cooling circuit according to claim 10, wherein
the second heat-generating device is provided with a second bypass in the form of a second bypass line,
the second proportional multi-way valve further includes a third outlet which is connected to the second bypass line, and
the second bypass line opens into the inlet of the second circulation pump.

12. The cooling circuit according to claim 1, wherein
the vehicle is an electric vehicle, and
the first heat-generating device is a battery of the electric vehicle and the second heat-generating device is a motor with a drive train of the electric vehicle.

13. The cooling circuit according to claim 1, further comprising
a third heat-generating device having a coolant inlet and a coolant outlet, which requires the coolant at a third coolant temperature level, wherein
the first heat-generating device and the third heat-generating device are connected in parallel to the refrigeration machine.

14. The cooling circuit according to claim 13, wherein
the third heat-generating device is provided with a third bypass in the form of a third bypass line,
the pump arrangement includes a third circulating pump,
the valve arrangement includes a third multi-way valve,
the third multi-way valve has an inlet, a first outlet, a second outlet, and a third outlet,
the coolant outlet of the third heat-generating device is connected to the inlet of the third multi-way valve,
the first outlet of the third multi-way valve is connected to the coolant inlet of the refrigeration machine,
the second outlet of the third multi-way valve is connected to the coolant inlet of the single cooler,
the third outlet of the third multi-way valve is connected to the third bypass line, and
the third bypass line opens into an inlet of the third circulating pump.

15. A method for operating the cooling circuit according to claim 1, comprising
distributing a flow of the coolant from the heat-generating devices to the single cooler and/or to the refrigeration machine and/or to the bypass by means of the valve arrangement to adjust the temperature of the coolant at the coolant inlets by varying the flow rate of the coolant to the single cooler and/or to the refrigeration machine and/or to the bypass by means of the electronic control module.

16. The method according to claim 15, wherein
the bypass includes a first bypass and a second bypass, the method further comprising:
if an ambient temperature is below a first temperature level,
recirculating the flow of the coolant from the first heat-generating device by means of the first bypass;
feeding a portion of the flow of the coolant from the second heat-generating device to the refrigeration machine; and
recirculating a portion of the flow of the coolant from the second heat-generating device by means of the second bypass.

17. The method according to claim 16, further comprising
if the ambient temperature is below a first temperature level,
feeding a portion of the flow of the coolant from the first heat-generating device to the refrigeration machine; and
recirculating a portion of the flow of the coolant from the first heat-generating device by means of the first bypass.

18. The method according to claim 15, wherein
the bypass includes a first bypass and a second bypass, the method further comprising:
if an ambient temperature is above a first temperature level and below a second temperature level,
feeding a portion of the flow of the coolant from the first heat-generating device to the single cooler;
recirculating a portion of the flow of the coolant from the first heat-generating device by means of the first bypass;
feeding a portion of the flow of the coolant from the second heat-generating device to the single cooler; and
recirculating a portion of the flow of the coolant from the second heat-generating device by means of the second bypass.

19. The method according to claim 18, further comprising
if the ambient temperature is above the second temperature level and below a third temperature level,
feeding a portion of the flow of the coolant from the first heat-generating device to the refrigeration machine; and
feeding a portion of the flow of the coolant from the first heat-generating device to the single cooler.

20. The method according to claim 18, further comprising
if the ambient temperature is above a third temperature level,
feeding a portion of the flow of the coolant from the first heat-generating device to the single cooler; and
recirculating a portion of the flow of the coolant from the first heat-generating device by means of the first bypass.

21. The method according to claim 15, further comprising:
if an ambient temperature is above a third temperature level,
feeding all of the flow of the coolant from the first heat-generating device to the refrigeration machine; and
feeding all of the flow of the coolant from the second heat-generating device to the single cooler.
